(19) United States
(12) Patent Application Publication
(10) Pub. No.: US 2011/0196006 A1
(43) Pub. Date: Aug. 11, 2011

(54) IMAZALIL COMPOSITIONS COMPRISING ALKOXYLATED AMINES

(76) Inventors: Dany Leopold Jozefien Bylemans, Hasselt (BE); Jan Pieter Hendrik Bosselaers, Beerse (BE); Mark Arthur Josepha Van Der Flaas, Herselt (BE)

(21) Appl. No.: 13/087,594

(22) Filed: Apr. 15, 2011

Related U.S. Application Data
(63) Continuation of application No. 11/660,822, filed on Feb. 21, 2007.

(30) Foreign Application Priority Data
Aug. 25, 2004 (EP) 04104075.9

(51) Int. Cl. A01N 43/50; A01P 3/00

(52) U.S. Cl. 514/399

(57) ABSTRACT

The present invention relates to the use of alkoxylated amines to enhance the activity of fungicidal formulations comprising the fungicidal compound imazalil. It also relates to formulations comprising imazalil and alkoxylated amines. These formulations are useful to protect materials, plants, fruits or seeds against fungi.

The present invention relates to the use of alkoxylated amines to enhance the activity of fungicidal formulations comprising the fungicidal compound imazalil. It also relates to formulations comprising imazalil and alkoxylated amines. These formulations are useful to protect materials, plants, fruits or seeds against fungi. Imazalil is a well known systemic fungicide with protective and curative action and is used to control a wide range of fungi on fruit, vegetables, and ornamentals.

Imazalil is also used as a seed dressing and for post harvest treatment of citrus, banana, and other fruit to control storage decay. Imazalil is the generic name of the compound 1-[2-(2,4-dichlorophenyl)-2-(2-propenyloxy)ethyl)]-1H-imidazole, which may be represented by the formula

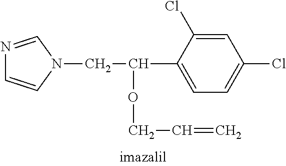

JP-61-151102 discloses the use of alkoxylated diamines for stabilizing formulations comprising 1H-1,2,4-triazole-1-ethanimidothioic acid fungicides such as imibenconazole.

EP-1,273,233-A1 discloses formulations comprising bethoxazin and alkoxylated amines for the protection of objects made of wood, biodegradable material and textiles against deterioration due to the action of fungi. And WO-03/065807 discloses formulations comprising fungicidal triazoles and alkoxylated amines for the protection of living and non-living materials against fungi.

Steurbaut W. et al. describes in “Improvement of fungicide performance by the addition of surfactants to the formulations. Part I: influence of physicochemical properties and spray performance”, published in Med. Fac. Landbouww. Rijksuniv. Gent 54/2a, p. 207-218 (1989), the influence of certain surfactants, such as e.g. Atplus 284 which is a polyethoxylated tallow alkyl amine, on physicochemical properties of certain fungicides, such as e.g. imazalil. From surface tension and contact angle measurements it was concluded that Atplus 284 was not a good wetter nor did it improve spreading coefficients. In “Part II: influence on biological and systemic activity”, published in Med. Fac. Landbouww. Rijksuniv. Gent 54/2b, p. 219-232 (1989), Steurbaut W. et al. describes the influence of the same surfactants on the leaf penetration, phytotoxicity and fungitoxicity of certain fungicides. No data are given on the effect of Atplus 284 on the fungitoxicity of imazalil.

Surprisingly, it has been found that, within certain broad limits of composition (i.e. certain respective proportions or amounts of the active ingredients easily determinable by those skilled in the art) by addition of alkoxylated amines of formula (I), the fungicidal efficacy of formulations comprising imazalil is significantly increased. Therefore the fungicidal formulations of the present invention comprise imazalil and alkoxylated amines of formula (I) in order to increase the efficacy or performance of these formulations in protecting plants, fruit or seeds against fungal infections or diseases or in protecting materials against fungal growth and damage.

The antifungal compound imazalil may be present in its free base form or in the form of an acid addition salt, the latter being obtained by reaction of the base form with an appropriate acid. Appropriate acids comprise, for example, inorganic acids, such as the hydrohalic acids, i.e. hydrofluoric, hydrochloric, hydrobromic and hydroiodic, sulfuric acid, nitric acid, phosphoric acid, phosphinic acid and the like; or organic acids, such as, for example, acetic, propanoic, hydroxyacetic, 2-hydroxy-propanoic, 2-oxopropanoic, ethanedioic, propanedioic, butanedioic, (Z)-2-butenedioic, (E)-2-butenedioic, 2-hydroxybutanedioic, 2,3-dihydroxy-butanedioic, 2-hydroxy-1,2,3-propanetricarboxylic, methanesulfonic, ethanesulfonic, benzenesulfonic, 4-methyl-benzenesulfonic, cyclohexanesulfamic, 2-hydroxybenzoic, and the like acids.

Particular salt forms of imazalil are the sulfate, phosphate, acetate, nitrate or phosphite salts.

Imazalil has one asymmetric carbon atom and can therefore be used in the embodied compositions in the form of a mixture of both enantiomers, in particular a racemic mixture, or in the form of a substantially pure (R)- or (S)-enantiomer.

Whenever the term ‘imazalil’ is used in the present invention, it is meant to include any salt, enantiomer or mixture of (R)- or (S)-enantiomers thereof.

The alkoxylated amines of formula (I) have the following general formula

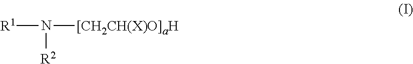

wherein
R¹ is a C₈₋₂₀alkyl;
R² is —[CH₂CH(X)O]_{b}H (a-1)

or

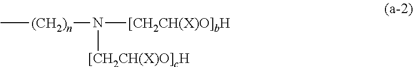

n is an integer from 1 to 4;
each a, b, and c independently are integers which can be 1 to 20;
each X independently is selected from the group consisting of hydrogen, methyl, ethyl, and phenyl; with the proviso that the compound wherein R¹ is C₁₆₋₁₈alkyl, R² is (a-1) and a and b are the integer 1 is not included.

A group of interesting compounds of formula (I) are those compounds of formula (I) wherein each a, b, and c independently are integers which can be 1 to 6.

A first particular group of alkoxylated amines of formula (I) are those compounds of formula (I) wherein R² represents radical (a-1).

A second particular group of alkoxylated amines of formula (I) are those compounds of formula (I) wherein R² represents radical (a-2).

More particular alkoxylated amines of formula (I) are those alkoxylated amines of formula (I) wherein one or more of the following restrictions apply:

a) n is an integer 2 or 3, preferably n is 3;
b) X is hydrogen;
c) R is a C₁₀₋₂₀alkyl, preferably cocoalkyl or tallowalkyl.

Commercially available alkoxylated amines of formula (I) wherein R² represents radical (a-1) are listed in the following table:

| Product name | Chemical name |
|---|---|
| Ethomeen C/12 | bis-(2-hydroxyethyl)cocoalkylamine |
| Ethomeen C/15 | ethoxylated(5)cocoalkylamine |
| Ethomeen C/25 | ethoxylated(15)cocoalkylamine |
| Ethomeen O/12 | bis-(2-hydroxyethyl)oleylamine |
| Ethomeen O/17 | ethoxylated(7)oleylamine |
| Ethomeen O/20 | ethoxylated(10)oleylamine |
| Ethomeen S/15 | ethoxylated(5)soyaalkylamine |
| Ethomeen S/25 | ethoxylated(15)soyaalkylamine |
| Ethomeen T/12 | bis-(2-hydroxyethyl)tallowalkylamine |
| Ethomeen T/15 | ethoxylated(5)tallowalkylamine |
| Ethomeen T/25 | ethoxylated(15)tallowalkylamine |
| Ethomeen HT/12 | bis-(2-hydroxyethyl) hydrogenatedtallowalkylamine |
| Ethomeen HT/14 | ethoxylated(4) hydrogenatedtallowalkylamine |
| Ethomeen HT/17 | ethoxylated(7) hydrogenatedtallowalkylamine |
| Ethomeen HT/20 | ethoxylated(10) hydrogenatedtallowalkylamine |
| Ethomeen HT/25 | ethoxylated(15) hydrogenatedtallowalkylamine |
| Ethomeen HT/30 | ethoxylated(20) hydrogenatedtallowalkylamine |
| Ethomeen 12/12 | bis-(2-hydroxyethyl)dodecylamine |
| Ethomeen 18/12 | bis-(2-hydroxyethyl)octadecylamine |

Commercially available alkoxylated amines of formula (I) wherein R² represents radical (a-2) are listed in the following table:

| Product name | Chemical name |
|---|---|
| Propoduomeen C13 | N,N′,N′-tris(2-hydroxypropyl)-N- |
| | cocoalkyl-1,3-diaminopropane |
| Ethoduomeen T11 | mono-(2-hydroxyethyl)-N-tallowalkyl-1,3- |
| | diaminopropane |
| Ethoduomeen T13 | N,N′,N′-tris-(2-hydroxyethyl)-N- |
| | tallowalkyl-1,3-diaminopropane |
| Ethoduomeen T25 | N,N′,N′-polyoxyethylene(15)-N- |
| | tallowalkyl-1,3-diaminopropane |
| Ethoduomeen C13 | N,N′,N′-tris(2-hydroxyethyl)-N- |
| | cocoalkyl-1,3-diaminopropane |

Most preferred alkoxylated amine of formula (I) is N,N′,N′-tris(2-hydroxyethyl)-N-cocoalkyl-1,3-diaminopropane (=Ethoduomeen T13).

The compositions of the present invention are active against a broad range of phytophatogenic fungi. As examples of such fungi there may be named Ascomycetes (e.g. Venturia, Podosphaera, Erysiphe, Monilinia, Uncinula, Aureobasidium, Sclerophoma); Basidiomycetes (e.g. Hemileia, Rhizoctonia, Puccinia, Coniophora, Serpula, Poria, Uromyces, Gloeophyllum, Lentinus, Coriolus, Irpex); Fungi imperfecti (e.g. Botrytis, Helminthosporium, Rhynchosporium, Fusarium, Septoria, Cercospora, Alternaria, Pyricularia, Penicillium, Geotrichum).

The relative proportions of imazalil and alkoxylated amines of formula (I) in the embodied fungicidal compositions are those proportions which result in unexpected enhanced efficacy, preferably synergistic, against fungi, when compared to a composition including, as an active ingredient, either imazalil alone or alkoxylated amines of formula (I) alone. As will readily be understood by those skilled in the art, the said enhanced efficacy may be obtained within various proportions of imazalil and alkoxylated amines of formula (I) in the fungicidal composition, depending on the kind of fungus towards which efficacy is measured and the substrate to be treated. As a general rule, however, it may be said that for most fungi the suitable proportions by weight of the amount of imazalil to alkoxylated amines of formula (I) in the compositions of the present invention should lie in the range from 5:1 to 1:50, preferably 4:1 to 1:4.

The amount of imazalil and of the alkoxylated amines of formula (I), in the compositions according to the present invention will be so that an effective fungicidal effect is obtained. In particular it is contemplated that the ready-to-use compositions of the present invention comprise imazalil in a range from 0.001% (w/v) to 1% (w/v), preferably from 0.01% (w/v) to 0.1% (w/v). Alkoxylated amines of formula (I) in such ready-to-use compositions are present in a range from 0.01% (w/v) to 10% (w/v), preferably from 0.1% (w/v) to 1% (w/v). Said ready-to-use compositions may be obtained by diluting a concentrated composition with an appropriate diluent such as e.g. water.

In many instances the fungicidal compositions to be used directly can be obtained from concentrates, such as e.g. emulsifiable concentrates, suspension concentrates, or soluble concentrates, upon dilution with aqueous or organic media, such concentrates being intended to be covered by the term composition as used in the definitions of the present invention. Such concentrates can be diluted to a ready to use mixture in a spray tank shortly before use. Preferably the compositions of the invention should contain from about 0.01 to 95% by weight of the combination of imazalil and alkoxylated amines of formula (I). More preferably this range is from 0.1 to 90% by weight. Most preferably this range is from 1 to 80% by weight, depending on the type of formulation to be selected for specific application purposes, as further explained in details hereinafter.

An emulsifiable concentrate is a liquid, homogeneous formulation of imazalil and alkoxylated amines of formula (I) to be applied as an emulsion after dilution in water. A suspension concentrate is a stable suspension of the active ingredients in a fluid intended for dilution with water before use. A soluble concentrate is a liquid, homogeneous formulation to be applied as a true solution of the active ingredients after dilution in water.

The fungicidal compositions of the present invention can also be formulated as waxes for use as a cover or coating of e.g. fruit, in particular citrus fruit.

The carriers present in the compositions of the invention are any material or substance with which the composition of imazalil and alkoxylated amines of formula (I) is formulated in order to facilitate its application/dissemination to the locus to be treated, for instance by dissolving, dispersing, or diffusing the said composition, and/or to facilitate its storage, transport or handling without impairing its antifungal effectiveness. Said acceptable carriers may be a solid, a liquid or a gas which has been compressed to form a liquid, i.e. the compositions of this invention can suitably be used as concentrates, emulsions, emulsifiable concentrates, oil miscible suspension concentrates, oil-miscible liquid, soluble concentrates, solutions, granulates, dusts, sprays, aerosols, pellets, or powders.

Suitable carriers for solid formulations, such as dusts, dispersable or flowable powders, are any dispersant that does not adversely affect the active ingredients, for example, clays (for example, kaolin, bentonite, acid clay, and the like), talcs (for example, talc powder, agalmatolite powder, and the like), silicas (for example, diatomaceous earth, silicic acid anhydride, mica powder, and the like), alumina, sulfur powder, activated charcoal, and the like. These solid carriers may be used either singly or in combination of two or more species

Appropriate carriers for liquid formulations are any liquid that does not adversely affect the active ingredients, for example, water, alcohols (for example, methyl alcohol, ethyl alcohol, ethylene glycol, propylene glycol, diethylene glycol, glycerin, etc.), ketones (for example, acetone, methyl ethyl ketone, etc.), ethers (for example, dioxane, tetrahydrofurane, cellosolve, diethylene glycol dimethyl ether, etc.), aliphatic hydrocarbons (for example, hexane, kerosene, etc.), aromatic hydrocarbons (for example, benzene, toluene, xylene, solvent naphtha, methyl naphthalene, etc.), halogenated hydrocarbons (for example, chloroform, carbon tetrachloride, etc.), acid amides (for example, dimethyl formadide, etc.), esters (for example, methyl acetate ester, ethyl acetate ester, butyl acetate ester, fatty acid glycerin ester, etc.), and nitriles (for example, acetonitrile, etc.). These solvents may be used either singly or in combination of two or more species.

The compositions of the present invention may further comprise suitable substances known in the art of formulation, such as, for example natural or regenerated mineral substances, solvents, dispersants, surfactants, wetting agents, adhesives, thickeners, binders, anti-freeze agents, repellents, colour additives, corrosion inhibitors, water-repelling agents, siccatives, UV-stabilizers and other active ingredients. Suitable surfactants are non-ionic, cationic and/or anionic surfactants having good emulsifying, dispersing and wetting properties. The term “surfactants” will also be understood as comprising mixtures of surfactants.

Depending the nature of the compositions, the methods of application, such as spraying, atomizing, dusting, scattering or pouring, are chosen in accordance with the intended objectives and the prevailing circumstances.

The fungicidal compositions according to the present invention possess advantageous curative, preventive and antisporulant fungicidal activity to protect plants, fruit and seeds. The present mixtures can be used to protect plants or parts of plants, e.g. fruit, blossoms, flowers, foliage, stems, roots, cuttings, tubers of plants or culture plants infected, harmed or destroyed by fungi, whereby later-growing parts of plants are protected against fungal infections, or diseases and concomitant damage.

As examples of the wide variety of culture plants in which the compositions of the present invention can be used, there may be named for example cereals, e.g. wheat, barley, rye, oats, rice, sorghum and the like; beets, e.g. sugar beet and fodder beet; pome and stone fruit and berries, e.g. apples, pears, plums, peaches, almonds, cherries, strawberries, kiwi, grapes, raspberries and blackberries; leguminous plants, e.g. beans, lentils, peas, soy beans; oleaginous plants, e.g. rape, mustard, poppy, olive, sunflower, coconut, castor-oil plant, cocoa, ground-nuts; cucurbitaceae, e.g. pumpkins, gherkins, melons, cucumbers, squashes; fibrous plants, e.g. cotton, flax, hemp, jute; citrus fruit, e.g. orange, lemon, grapefruit, mandarin; vegetables, e.g. spinach, lettuce, asparagus, brassicaceae such as cabbages and turnips, carrots, onions, tomatoes, potatoes, hot and sweet peppers; laurel-like plants, e.g. avocado, cinnamon, camphor tree; or plants such as maize, tobacco, nuts, coffee, sugar-cane, tea, vines, hops, bananas, rubber plants, as well as ornamental plants, e.g. flowers, shrubs, deciduous trees and evergreen trees such as conifers. This enumeration of culture plants is given with the purpose of illustrating the invention and not to delimiting it thereto.

A particular mode of administering an antifungal composition of the present invention, is the administration to the aboveground parts of plants, in particular to the leaves thereof (leaf-application). The number of applications and the administered doses are chosen in accordance with the biological and climatic conditions of life of the causative fungus. The antifungal compositions though, can also be applied to the soil and get into the plants through the root system (systemic activity), in case the locus of the plants is sprayed with a liquid composition or if the components are added to the soil in a solid formulation e.g. in the form of a granulate (soil application).

The antifungal compositions of the present invention are particularly useful in post-harvest treatment of fruit, especially citrus fruit. In the latter instance, the fruit will be sprayed with or dipped or drenched into a liquid formulation or the fruit may be coated with a waxy composition. The latter waxy composition conveniently is prepared by thoroughly mixing a suspension concentrate with a suitable wax. The formulations for spray, dip or drench applications may be prepared upon dilution of a concentrate such as, e.g. an emulsifiable concentrate, a suspension concentrate or a soluble liquid, with an aqueous medium. Such concentrate in most instances consists of the active ingredients, a dispersing or suspending agent (surfactant), a thickening agent, a small amount of organic solvent, a wetting agent, optionally some anti-freeze agent, and water.

The fungicidal compositions of the present invention can also be used for protecting seed against fungal infections or fungal diseases. To that effect the present fungicidal compositions can be coated on seed, in which case the seed grains are drenched consecutively with a liquid composition of the active ingredients or if they are coated with a previously combined composition.

The fungicidal compositions of the present invention are also useful to protect metal working fluids, paints and coatings, in-tank/in-can protection of aqueous functional fluids, e.g. polymer emulsions, water based paints and adhesives, glues, starch slurries, thickener solutions, gelatine, wax emulsions, inks, fount solutions, polishes, pigment and mineral slurries, rubber latexes, concrete additives, drilling muds, toiletries, aqueous cosmetic formulations, pharmaceutical formulations and the like, against fungi.

Apart from imazalil and the alkoxylated amines of formula (I), the compositions of the present invention may further comprise additional biocidal agents, such as fungicides, bactericides, acaricides, nematocides, insecticides or herbicides, in particular fungicides. These additional biocidal agents are used to widen the spectrum of action and/or to prevent the build up of resistance. In many cases, this may result in synergistic effects, i.e. the activity of the mixture exceeds the activity of the individual components.

As additional biocidal agents there may be considered products of the following classes:

Fungicides:

2-aminobutane; 2,6-di-chloro-N-(4-trifluoromethylbenzyl)benzamide (XRD-563); 8-hydroxyquinoline sulphate; 4-[3-(3,4-dimethoxyphenyl)-3-(4-fluorophenyl)-acryloyl]morpholine (SYP-L190); 2-(thiocyanatomethylthio)benzo[d]thiazole (TCMTB); 4,7-dimethyl-1H-indole-2-carboxylic acid, methyl ester (OK-9601); 1-(2,6-dichloro-phenyl)-3,4-dihydro-6,7-dimethoxy-isoquinoline (NSC-338509); 1-[(4-chlorophenyl)-methyl]-4-phenyl-piperidine dodecanoate (AC-902202); cis-(±)-1-(4-chlorophenyl)-2-(1H-1,2,4-triazol-1-yl)-cycloheptanol (SSF-109); 6-bromo-5-[(3,5-dimethyl-4-isoxazolypsulfonyl]-2,2-difluoro-5H-1,3-dioxolo[4,5-f]benzimidazole; 6-chloro-5-[(3,5-dimethyl-4-isoxazolypsulfonyl]-2,2-difluoro-5H-1,3-dioxolo[4,5-f]benzimidazole; 1-methoxy-1H-indole-3-carboxylic acid methyl ester; N-cyclohexylbenzo[b]thiophene-2-carboxamide 1,1-dioxide; (E)-O-2-deoxy-2-[(1-oxo-9-octadecenyl)amino]-β-D-glucopyranosyl-(1→4)-O-2-(acetylamino)-2-deoxy-β-D-glucopyranosyl-(1→4)-O-2-(acetylamino)-2-deoxy-β-D-glucopyranosyl-(1→4)-2-(acetylamino)-2-deoxy-D-glucose; (2S)—N-[2-[4-[[3-(4-chlorophenyl)-2-propynyl]oxy]-3-methoxyphenyl]ethyl]-3-methyl-2-[(methylsulfonyl)amino]butanamide; (3-chloro-6-hydroxy-2-methylphenyl)-(2,3,4-trimethoxy-6-methylphenyl)methanone; 2,4-dihydro-5-methoxy-2-methyl-4-[2-[[[[1-[3-(trifluoromethyl)phenyl]ethylidene]amino]oxy]methyl]phenyl]-3H-1,2,4-triazol-3-one; [(1S)-1-[[[(1R)-1-(6-fluoro-2-benzothiazolyl)ethyl]amino]carbonyl]-2-methylpropyl]-carbamic acid 1-methylethyl ester; 2,6-dichloro-N-[[3-chloro-5-(trifluoromethyl)-2-pyridinyl]methyl]-benzamide; N-(6-methoxy-3-pyridinyl)-cyclopropanecarboxamide (ICIA-0858); 1-(1,2,3,4-tetrahydro-1-naphthyl)-5-(ethoxycarbonyl)-imidazole (R10100) and its salts; 10-oxo-trans-8-decenoic acid; 5-hydroxy-2-hydroxymethyl-4H-pyran-4-one; 5-nitro-1-indanone; 3-[(3R,5S)-5-(4-chlorophenyl)-2,3-dimethyl-3-isoxazolidinyl]-pyridine (SYP-Z048); phenylphenol (OPP), 3-iodo-2-propynyl butylcarbamate (IPBC); acibenzolar-S-methyl, aldimorph, ampropylfos, anilazine, benalaxyl, benodanil, benomyl, benthiavalicarb-isopropyl, binapacryl, biphenyl, bitertanol, blasticidin-S, borax, boscalid, bupirimate, buthiobate, sec-butylamine, caffeine, calcium polysulphide, captafol, captan, carbendazim, carboxin, carpropamid, carvacrol, quinomethionate, chloroneb, chloropicrin, chlorothalonil, chlozolinate, chromofungin, trans-cinnamaldehyde, trans-cinnamic acid, cinnamyl alcohol, cryptosporiopsin, cufraneb, cyazofamid, cyflufenamid, cymoxanil, cyprodinil, cyprofuram, dazomet, debacarb, dichlorphen, diclobutrazol, diclocymet, diclomezine, dichlofluanid, diclomezin, dicloran, diethofencarb, difenzoquat metilsulfate, diflumetorim, dimethirimol, dimethomorph, dinobuton, dinocap, diphenylamine, dipyrithion, ditalimfos, dithianon, dodemorph, dodine, drazoxolon, echinocandin, edifenphos, ethirimol, ethaboxam, etridiazole, eugenol, famoxadone, fenamidone, fenarimol, fenfuram, fenhexamid, fenitropan, fenoxanil, fenpiclonil, fenpropidin, fenpropimorph, fentin acetate, fentin hydroxide, ferbam, ferimzone, fluazinam, fludioxonil, flumetover, flumorlin, fluorofolpet, fluoromide, flusulfamide, flutolanil, flutriafol, flusulfamide, folpet, fosetyl-aluminium, fthalide, fuberidazole, furalaxyl, furmecyclox, griseofulvin, guazatine, harpin, hexachlorobenzene, hinokitiol, hydroxy-jesterone, hymexazol, iminoctadine, iprobenfos (IBP), iprodione, iprovalicarb (fencaramid), isoprothiolane, jesterone, lanoconazole, kasugamycin, copper preparations such as: copper hydroxide, copper naphthenate, copper oxychloride, copper sulphate, copper oxide, oxine-copper and Bordeaux mixture, mancopper, mancozeb, maneb, mepanipyrim, mepronil, metalaxyl, methasulfocarb, methfuroxam, metiram, metrafenone, metsulfovax, myclobutanil, nabam, natamycin, nickel dimethyldithiocarbamate, nitrothal-isopropyl, nuarimol, NZ-1012, octhilinone, ofurace, oxadixyl, oxamocarb, oxycarboxin, pefurazoate, pencycuron, pentalongin, penthiopyrad, phomalactone, phosdiphen, phthalide, picobenzamid, pimaricin, piperalin, piroctone olamine, polyoxin, polyoxorim, probenazole, prochloraz, procymidone, propamocarb, propineb, propyl gallate, proquinazid, pseudomycin, pyrazophos, pyributicarb, pyrifenox, pyrimethanil, pyroquilon, pyrrolnitrin, quinoclamine, quinoxyfen, quintozene (PCNB), resveratrol, rustmicin, salicylanilide, silthiofam, spiroxamin, sulphur and sulphur preparations, tecloftalam, tecnazene, terpineol, terpinen-4-ol, theophylline, thiabendazole, thicyofen, thiophanate-methyl, thiram, tiadinil (NNF-9850), tolclophos-methyl, tolylfluanid, triazoxide, trichlamide, tricyclazole, tridemorph, triflumizole, triforine, umbelliferone, validamycin A, vinclozolin, zineb, ziram, zopfiellin, zosteric acid, zoxamide; isothia- and benzisothiazolone derivatives such as, e.g. 1,2-benzisothiazolone (BIT), N-alkyl 1,2-benzisothiazolones including 4,5-dichloro-2-(n-octyl)-3(2H)-isothiazolone (DCOIT), and 2-(n-octyl)-3(2H)-isothiazolone (OIT); fungicidal triazoles such as azaconazole, bitertanol, bromuconazole, cyproconazole, difenoconazole, diniconazole, epoxiconazole, fenarimol, fenbuconazole, fluquinconazole, flusilazole, flutriafol, hexaconazole, imibenconazole, ipconazole, ketoconazole, metconazole, myclobutanil, oxpoconazole, penconazole, propiconazole, prothioconazole, simeconazole, tebuconazole, tetraconazole, triadimefon, triadimenol, and triticonazole; fungicidal triazolopyrimidines like 5-chloro-6-(2-chloro-6-fluorophenyl)-7-(4-methyl-1-piperidinyl)-2-[1,2,4]triazolo[1,5-a]pyrimidine; 5-chloro-N-(2,2,2-trifluoro-1-methylethyl)-6-(2,4,6-trifluorophenyl)-[1,2,4]triazolo[1,5-a]pyrimidin-7-amine; 5-chloro-N-(2,2,2-trifluoroethyl)-6-(2,4,6-trifluorophenyl)-[1,2,4]triazolo[1,5-a]pyrimidin-7-amine; fungicidal thienopyrimidinones like 6-chloro-2-propoxy-3-propyl-thieno[2,3-d]pyrimidin-4(3H)-one; strobilurines such as azoxystrobin, dimoxystrobin, enestroburin (SYP-Z071), fluoxastrobin, metominostrobin, orysastrobin, pyraclostrobin, kresoxim-methyl, trifloxystrobin, picoxystrobin, 2-[[[cyclopropyl[(4-methoxyphenyl)imino]methyl]thio]-methyl]-α-(methoxymethylene)-benzeneacetic acid methyl ester (UBF-307) and (E,E)-α-(methoxyimino)-N-methyl-2-[[[1-[3-(trifluoromethyl)phenyl]ethoxy]imino]methyl]-benzeneacetamide (MA-565).

Bactericides:

bronopol, dichlorophen, nitrapyrin, nickel dimethyldithiocarbamate, kasugamycin, octhilinone, furanecarboxylic acid, oxytetracyclin, streptomycin, tecloftalam, copper sulphate and other copper preparations.

Insecticides/Acaricides/Nematicides:

abamectin, AC 303 630, acephate, acrinathrin, alanycarb, aldicarb, alphamethrin, amitraz, avermectin, AZ 60541, azadirachtin, azinphos A, azinphos M, azocyclotin, Bacillus thuringiensis, bendiocarb, benfuracarb, bensultap, beta-cyfluthrin, bifenthrin, BPMC, brofenprox, bromophos A, bufencarb, buprofezin, butocarboxin, butylpyridaben, cadusafos, carbaryl, carbofuran, carbophenothion, carbosulfan, cartap, CGA 157 419, CGA 184699, chloethocarb, chlorethoxyfos chlorfenvinphos, chlorfluazuron, chliormephos, chlorfenapyr, chlorpyrifos, chlorpyrifos M, cis-resmethrin, clocythrin, clofentezine, cyanophos, cycloprothrin, cyfluthrin, cyhalothrin, cyhexatin, cypermethrin, cyromazine, deltamethrin, demeton-M, demeton-S, demeton-S-methyl, diafenthiuron, diazinon, dichlofenthion, dichlorvos, dicliphos, dicrotophos, diethion, diflubenzuron, dimethoate, dimethylvinphos, dioxathion, disulfoton, edifenphos, emamectin, esfenvalerate, ethiofencarb, ethion, ethofenprox, ethoprophos, etrimphos, fenamiphos, fenazaquin, fenbutatin oxide, fenitrothion, fenobucarb, fenothiocarb, fenoxycarb, fenpropathrin, fenpyrad, fenpyroximate, fenthion, fenvalerate, fipronil, fluazinam, flucycloxuron, flucythrinate, flufenoxuron, flufenprox, fluvalinate, fonophos, formothion, fosthiazate, fubfenprox, furathiocarb, HCH, heptenophos, hexaflumuron, hexythiazox, imidacloprid, iprobenfos, isazophos, isofenphos, isoprocarb, isoxathion, ivemectin, lambda-cyhalothrin, lufenuron, malathion, mecarbam, mervinphos, mesulfenphos, metaldehyde, methacrifos, methamidophos, methidathion, methiocarb, methomyl, metolcarb, milbemectin, monocrotophos, moxidectin, naled, NC 184, NI 25, nitenpyram, omethoate, oxamyl, oxydemethon M, oxydeprofos, parathion A, parathion M, permethrin, phenthoate, phorate, phosalone, phosmet, phosphamdon, phoxim, pirimicarb, pirimiphos M, pirimiphos A, profenofos, promecarb, propaphos, propoxur, prothiofos, prothoate, pymetrozin, pyrachlophos, pyridaphenthion, pyresmethrin, pyrethrum, pyridaben, pyrimidifen, pyriproxifen, quinalphos, RH 5992, salithion, sebufos, silafluofen, sulfotep, sulprofos, tebufenozid, tebufenpyrad, tebupirimiphos, teflubenzuron, tefluthrin, temephos, terbam, terbufos, tetrachlorvinphos, thiafenox, thiamethoxam, thiodicarb, thiofanox, thiomethon, thionazin, thuringiensin, tralomethrin, triarathen, triazophos, triazuron, trichlorfon, triflumuron, trimethacarb, vamidothion, XMC, xylylcarb, zetamethrin.

An interesting combination of imazalil and alkoxylated amines of formula (I), which comprises an additional biocidal agent is the combination wherein said additional biocidal agent is a fungicide selected from boscalid, fenhexamid, pyrimethanil and thiabendazole.

### EXPERIMENTAL PART

### Experiment 1: Poison Plate Assay

Activity against growth of Microdochium nivale was determined with the poison plate assay. A calculated amount of a stock solution (containing either imazalil or an alkoxylated amine of formula (I) dissolved in dimethyl sulfoxide was pipetted into multiwell plates. Culture medium (potato dextrose agar) was added aseptically and uniform distribution was obtained by shaking. The plates were inoculated with the test fungus Microdochium nivale (suspension of 6.10⁵ spores/ml). The multi-well plates were kept in the dark at 21° C. and a relative humidity of 75%.

The stock solution comprising imazalil at a concentration of 2000 ppm was pipetted in the multiwell plates in order to reach a final test concentration in six decreasing steps ranging from 6.66, 5.00, 3.75, 2.81, 2.11 and 1.58 ppm.

The stock solution comprising an alkoxylated amine of formula (I) at a concentration of 8000 ppm was pipetted in the multiwell plates in order to reach a final test concentration in six decreasing steps ranging from 26.66, 20.00, 15.00, 11.25, 8.44, and 6.33 ppm wherein the ratio of imazalil to alkoxylated amine of formula (I) is 1 to 4 in each of the wells containing both imazalil and alkoxylated amine (I).

The lowest concentration of each test compound or mixture of test compounds sufficient to inhibit visible growth was taken as the minimum inhibitory concentration (MIC). The MIC were taken as end points of activity. End points for the combinations of imazalil with an alkoxylated amine of formula (I) were then compared with the end points for these test compound when employed individually.

TABLE 1
MIC-values

| Test Compound | | |
|---|---|---|
| imazalil | 2.81 | ppm |
| ethomeen C12 | >26.7 | ppm |
| ethoduomeen T13 | >26.7 | ppm |
| ethomeen C12 + imazalil | 2.11 | ppm |
| ethoduomeen T13 + imazalil | 2.11 | ppm |

### Experiment 2: Poison Plate Assay

A similar poison plate assay was run as described in Experiment 1, but the final concentrations of imazalil now ranged from 10, 7.50, 5.63, 4.22, 3.16 to 2.37 ppm. The final concentrations of alkoxylated amine of formula (I) now ranged from 40, 30, 22.50, 16.88, 12.66 to 9.49 ppm.

TABLE 2
MIC-values

| Test Compound | | |
|---|---|---|
| imazalil | 3.16 | ppm |
| ethoduomeen C13 | >40 | ppm |
| ethoduomeen C13 + imazalil | <2.37 | ppm |

1. A fungicidal composition comprising imazalil and alkoxylated amines of formula 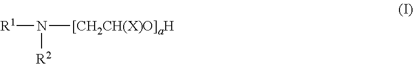
wherein
R¹ is a C₈₋₂₀alkyl;
R² is —[CH₂CH(X)O]_{b}H (a-1)
or 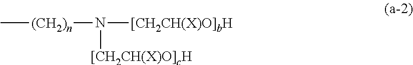
n is an integer from 1 to 4;
each a, b, and c independently are integers which can be 1 to 20;
each X independently is selected from the group consisting of hydrogen, methyl, ethyl, and phenyl, with the proviso that the compound wherein R¹ is C₁₆₋₁₈alkyl,
R² is (a-1) and a and b are the integer 1 is not included, in respective proportions such as to provide an enhanced antifungal effect of imazalil.

2. A composition according to claim 1 wherein the ratio of imazalil to alkoxylated amines of formula (I) ranges from 5:1 to 1:50.

3. A composition according to claim 1 wherein R² is a radical formula (a-1).

4. A composition according to claim 1 wherein R² is a radical formula (a-2).

5. A composition according to claim 1 wherein the alkoxylated amine of formula (I) is N,N′,N′-tris(2-hydroxyethyl)-N-cocoalkyl-1,3-diaminopropane.

6. A composition according to claim 1 wherein the alkoxylated amine of formula (I) is N,N′,N′-tris-(2-hydroxyethyl)-N-tallowalkyl-1,3-diaminopropane.

7. A composition according to claim 1 further comprising an additional biocidal agent.

8. A composition according to claim 7 wherein the additional biocidal agent is selected from boscalid, fenhexamid, pyrimethanil and thiabendazole.

9. (canceled)

10. The method according to claim 12 wherein the alkoxylated amine of formula (I) is N,N′,N′-tris(2-hydroxyethyl)-N-cocoalkyl-1,3-diamino-propane.

11. (canceled)

12. A method of protecting plants, fruit or seed against fungal infections or diseases which method comprises applying to the plants, fruit or seed a composition as claimed in claim 1.

13. A composition according to claim 1, wherein the ratio of imazalil to alkoxylated amines of formula (I) ranges from 4:1 to 1:4.

14. A composition according to claim 2, wherein the alkoxylated amine of formula (I) is N,N′,N′-tris(2-hydroxyethyl)-N-cocoalkyl-1,3-diaminopropane.

15. A composition according to claim 2, wherein the alkoxylated amine of formula (I) is N,N′,N′-tris-(2-hydroxyethyl)-N-tallowalkyl-1,3-diaminopropane.

16. The method of claim 12, wherein the alkoxylated amine of formula (I) is N,N′,N′-tris-(2-hydroxyethyl)-N-tallowalkyl-1,3-diaminopropane.
